(19) United States
(12) Patent Application Publication
(10) Pub. No.: US 2015/0188720 A1
(43) Pub. Date: Jul. 2, 2015

(54) Method for Video Based Social Media Networking

(71) Applicant: Alex Winter, Van Nuys, CA (US)

(72) Inventor: Alex Winter, Van Nuys, CA (US)

(21) Appl. No.: 14/274,059

(22) Filed: May 9, 2014

Related U.S. Application Data
(63) Continuation-in-part of application No. 14/143,229, filed on Dec. 30, 2013.

(51) Int. Cl. H04L 12/18; G06F 17/30; G06F 3/0481

(52) U.S. Cl. CPC H04L 12/1813; G06F 3/0481; G06F 17/30595

(57) ABSTRACT

A computer-based social media network application providing socially networked friends the ability to create video-based challenges and responses to those challenges. The application allows users to easily edit the videos and apply multiple filters. In order to enhance participation, a score and rank based on participation, performance, and other criteria will be tracked and determined. For opt-in participants, the rank may lead to the user being offered an incentive, such as an offer or share of the company and providing and controlling the application. The application may allow businesses to advertise redeemable deals to social media users based on factors, such as geographic location of the business and social media networking users and participation of the social media networking users within the application. Deals allow businesses to monetize the application without intrusive ads. The application may also provide links to social media networking users to other web pages.

This application is a continuation-in-part of application Ser. No. 14/143,229, filed on Dec. 20, 2013.

### FIELD OF INVENTION

The present disclosure generally relates to computer-based methods and systems for social media networking, and, more particularly, to software applications that: (1) allow users to create or respond to fully functional video challenges. (2) rank individuals based off of their participation in the global network, (3) possibly, offer an IPO/stocks, stake in the company per verified and active user in the global network based on rank determined by activity level and invited downstream activity level; and (4) allow a vendor to interact with customers in a creative manner: a) user generated advertisement through network engagement; b) vendor inspired engagement; and c) user incentives/offers from vendors generated based of activity and tagging of geo-location.

### BACKGROUND

Video- and photo-based social media networking websites (sometimes referred to as image-based social media networking websites) were recently developed to offer users various and very limited ways to share, post, and forward photos and videos. Examples of currently available image-based social media networking websites generally include Snapchat®, Instagram®, Cube7™, Vine™, Keek™, Mixbit™, Tout™, and Rippln™. These image-based, social media networking websites grew out of a desire to more easily and quickly post images online and/or to easily alter images before posting them online. As such, these networking sites have generally made the social media networking experience more abbreviated than more fully developed social media networking websites, such as Facebook®.

Snapchat® generally allows users to share ultra-short and allegedly temporary videos and photos, but there are only minimal video customizations. Originally, Snapchat® focused on privacy and the deleting of the photographs/videos soon after sharing was accomplished. However, Snapchat® now allows users to keep a post visible for 24 hours.

Vine™ is generally a video-only social media network that allows users to comment on the videos and re-share them using the “revine” option. Vine™ users have profiles in the form of feeds that are archived and may generally explore videos of other Vine™ users through the public interface.

Instagram® is generally an image-based social media network, wherein users have the ability to apply special, but limited, filters to images. Instagram® also allows users to like and/or comment on videos and apply special filters to the videos. Generally, users have a profile that archives their posts.

Cube7™ is generally a fully functional social media network, where users may become Partner Members, which allows them to buy into the company, similar to a multi-level marketing company. Cube7™ intends to reward their users with points called “Cubix” for up to six tiers of downstream friends, including friends of friends. Specifically, if a user intends on making a profit from the network, that user must buy into the company. Also, non-paying in users receive a bonus of credits to be used or “spent” within the network.

Rippln™ is generally a network of monetized mobile and web-based apps that run within the confines of affiliate relationships. Users may generally profit on Rippln™ by building a social influence and are typically rewarded commissions based on downstream purchases and activities.

These conventional image-based social media networking websites and apps are not based around giving back to the most active and influential users, nor are the users rewarded any significant stake in the company.

Thus, what is needed is a computer-based method of providing an image-based social media networking website and/or app that allows users to create videos using advanced filters, and, in a truth or dare manner, challenge one or more other networked users, allow the challenged users to respond to those challenges, declare a winner from the respondents, comment or approve of the challenges and responses, determine the weight or strength of each type of activity that a user engages in, assign a score to users based on their activity, rank the users based on the scores, reward the highest-ranking users with a stake in the company, and provide for unobtrusive advertising.

### SUMMARY

To minimize the limitations in the prior art, and to minimize other limitations that will become apparent upon reading and understanding the present specification, the foregoing discloses a new and useful computer-based method for image-based social media networking.

The method may provide a way to give back to the most active and influential users of the image-based social media networking mobile app and website. The method may track all user activity on the mobile and web portal and, by using simple algorithms, determine the weight or strength of each type of user activity. This may generate a score, and as the user's score rises, the user may build a global rank on the network. The user's rank may be based on his or her score as it is relative to the total of all scores or other users' scores. Depending on the user's rank, a fair share for the user in the operating company may then be determined. Users are not required to participate or buy in, as the network by itself is fun to use with a no pressure monetization path.

The method may have an advanced video editor that allows the scrub to any time position of the video and essentially edit the video with as much creativity as the user may imagine. The method may also provide the capability to change video filters multiple times within the same concurrent video.

The context in which users create videos may be in a “truth or dare” fashion. The user may create a challenge (dare) for one or more friends, or associated users, with the option to share this post on that user's other social media networks and/or on that user's public profile. The initiating user's friends may then have the opportunity to respond to the challenge in any way they want. The original challenger may review the responses and select a winner.

The method may include an explore option in the app so that users may find ideas for their own challenges or just entertain themselves with all of the public facing challenges.

Trending public videos may be filtered and loaded onto the main website and explore area of the mobile app for users to follow, like, and comment.

Additionally the method may comprise a business users section on the web portal to allow businesses to create profiles that may have the extra functionality of offers (named Q'Pon). This may allow the business to make discounts or free offers for customers and potential customers.

Users may redeem these offers through the app when they create or respond to a challenge at a physical location of a participating business. Users may also have an option to search for local deals/offers (called Q'Pons). This may provide a service to the business and the users without having intrusive ads.

One embodiment may be a computer-based method comprising: providing computer application software for mobile phones, portable media players, and computers; allowing a social media networking user to create an online user profile; wherein the social media networking user can create the online user profile to participate in video-based social media networking; wherein digital videos can be sent from one of the online user profiles to other of the online user profiles; wherein the social media networking user can challenge other of the social media networking users using the digital videos; wherein other of the social media networking users can respond to the challenge by creating another of the digital videos; allowing the social media networking user to create the challenge for one of more friends; wherein one or more of the friends can view the challenge by pressing a viewing screen to play and pause the digital videos; wherein one or more of the friends must respond to the challenge within an allotted time frame after the viewing of the digital videos; wherein one or more of the friends can respond to the challenge by the social media networking user in any manner one or more of the friends wants; wherein the digital videos have three different states: unviewed, viewed, and replied; wherein the digital videos can remain unviewed for three days; wherein the social media networking user who challenged one or more of the friends can select the winner from one or more of the friends who responded to the challenge; providing the ability to edit the digital videos by scrubbing to any time position on the digital videos; wherein the editing of the digital videos includes the capability to change video filters multiple times within the same concurrent video; providing navigational buttons that allow the social media networking user to switch between each of the viewing screens, to select the friends to send the digital videos to, to flip the camera, to adjust the flash, and to navigate between the video filters; providing the option to explore the social media network so the social media networking user can find ideas for the challenges and entertain himself/herself with public videos; wherein the public videos will filter to the main application website and explore area of the computer application software for the social media networking user to follow, like, and comment on; notifying the social media networking user how to find friends' accounts on the global network; wherein the notification includes the specific phraseology “Qountr me”™; offering the social media networking user who decides to opt in to an initial public offering (IPO) program a stake in the company; generating a score for each type of social media networking activity; wherein the score consists of individual scoring units called “Q's”™; wherein the score is calculated using simple algorithms to determine the weight and strength of each type of social media networking activity for the social media networking user; wherein the score is based on the social media networking user's participation in the application, success with creating and responding to the digital videos, and victory with the challenges; wherein an increase in the “Q's”™ increases the social media networking user's rank in the global network; wherein the rank is based on the number of the “Q's”™ the social media networking user has acquired, divided by the total number of the “Q's”™ in circulation globally; wherein the rank is used to determine a fair split between each of the social media networking users who opt into the IPO program; wherein each of the social media networking users is not required to participate in the IPO program; providing a business users' section in the application to allow businesses to create a business profile; wherein the business users' section permits a business to tender discounts and free offers for customers and potential customers; wherein the discounts and free offers can be distributed to the social media networking user based on geographic and business participation; wherein the business can create the discounts and free offers based on customer participation and geographic location; wherein the social media networking uses can redeem the discounts and free offers through the application when the social media networking user creates or responds to the challenges at a physical location of a participating business; wherein the social media networking user is provided with an option to search for the discounts and free offers in the social media networking user's locality; providing online communications links that transfer the social media networking user to other local and global web pages; wherein the transfer provides access to websites for the business that is accessible via the global network; providing advertising, promotional, and telecommunications services for the business that has created the business profile in the business users' section; wherein the telecommunications services electronically transmit data, messages, and information; and wherein the application provides services to the business and the social media networking user without being intrusive with ads.

Another embodiment may be a computer-based method for providing an image-based social media network comprising: providing a first computer, at least one second computer, and at least one server; providing an imaged-based social media application; wherein the first computer comprises the social media application for a first user; wherein the at least one second computer comprises the social media application for at least one second user; wherein the social media application may be configured to allow the first user and the at least one second user to be socially networked; creating at least one video by the first user; wherein the social media application may be comprised of one or more image filters; wherein the one or more image filters allow the at least one video to be altered and edited as desired by the first user, uploading to the social media application the at least one created video; creating a challenge by the first user via the social media application; wherein the challenge may be comprised of the at least one created video; sharing the challenge with the at least one second user via the social media application; viewing the challenge by the at least one second user via the social media application; responding to the challenge by the at least one second user via the social media application, such that at least one response may be created, uploaded and shared with the first user; wherein the at least one response may be comprised of at least one response video; tracking by the social media application a plurality of activity engaged in by the first user and the plurality of activity engaged in by the at least one second user, such that the plurality of activity may be tracked for all users; generating by the social media application a score for each of the users based on the plurality of activity; ranking by the social media application the users based on the score of each of the users; and providing one or more incentives to a plurality of high ranking users. The method may or may not include the following alternative steps, elements, and/or features: creating a user profile by each of the users; wherein the at least one second user responds to the challenge within an allotted time duration after viewing of the challenge; wherein the challenge has three states: unviewed, viewed, and responded to; wherein the challenge can remain in the unviewed state for at least three days; selecting by the first user a winning response from the at least one response video; providing by the social media application an ability to comment on and approve of the challenge and the at least one response by the users; commenting on and approving of the challenge and the at least one response by the users; providing by the social media application an ability to comment on and approve of the challenge and the at least one response by a plurality of users not being challenged nor doing the challenging; commenting on and approving of the challenge and the at least one response by the plurality of users not being challenged nor doing the challenging; editing the challenge and the at least one response by scrubbing to any time position on the challenge and the at least one response; wherein the editing of the challenge and the at least one response may be comprised of changing the one or more image filters multiple times concurrently within the same challenge and within the same at least one response; wherein the first computer and the at least one second computer are further comprised of one or more display screens; displaying on the one or more display screens the social media application; wherein the social media application may be further comprised of one or more navigational buttons that are displayed on the one or more display screens; wherein the social media application may be further comprised of one or more viewing screens; switching between the one or more viewing screens, such that the users may browse between a plurality of networked friends, editing options, the one or more image filters, and video creation options; exploring by at least one of the users on the social media application a plurality of publically available challenges and responses; following by at least one of the users on the social media application one or more other users; notifying by the social media network application the users regarding how to find the one or more other users; wherein the one or more incentives are comprised of a share in the company owns, provides, or is controlling the social media network application; wherein the plurality of activity may be selected from the group of activities consisting of: creating videos; issuing challenges; responding to challenges; commenting on videos; approving of videos; being followed by other users; following other users; promoting the social media application; declaring winners of challenges; and being declared the winner of challenges; wherein the score of each of the users based on the plurality of activity of each of the users as compared to a total plurality of activity of all users; wherein not all of the users are required to participate in the ranking and the providing of the one or more incentives; providing within the social media application a business users section; creating by each of a plurality of business users a business user profile; tendering by one or more of the plurality of business users one or more discounts and offers to the users of the social media application; redeeming by the users the one or more discounts and offers through the social media application; wherein the redeeming may be comprised of responding to one or more challenges of the plurality of business users at one or more physical locations of the plurality of business users.

It is an object to overcome the deficiencies of current computer-based social media networking applications.

Additional embodiments will be understood from the following detailed description of the invention.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a screen capture of one embodiment of the image-based social media network application of the method and shows the login screen.

FIG. 2 is a screen capture of one embodiment of the image-based social media network application of the method and shows the registration screen.

FIG. 3 is a screen capture of one embodiment of the image-based social media network application of the method and shows an example registration.

FIG. 4 is a screen capture of one embodiment of the image-based social media network application of the method and shows the image creation, filtering, and editing screen.

FIG. 5 is a screen capture of one embodiment of the image-based social media network application of the method and shows the networked friend directory page.

FIG. 6 is a screen capture of one embodiment of the image-based social media network application of the method and shows the friends search page.

FIG. 7 is a screen capture of one embodiment of the image-based social media network application of the method and shows the friends selection page.

FIG. 8 is a screen capture of one embodiment of the image-based social media network application of the method and shows the challenge sent confirmation page.

FIG. 9 is a screen capture of one embodiment of the image-based social media network application of the method and shows the challenge inbox screen.

FIG. 10 is a screen capture of one embodiment of the image-based social media network application of the method and shows the challenge review screen.

FIG. 11 is a screen capture of one embodiment of the image-based social media network application of the method and shows the profile rank screen.

FIG. 12 is a screen capture of one embodiment of the image-based social media network application of the method and shows the comment screen.

FIG. 13 is a screen capture of one embodiment of the image-based social media network application of the method and shows the explore screen.

FIG. 14 is a screen capture of one embodiment of the image-based social media network application of the method and shows the user profile screen.

FIG. 15 is a screen capture of one embodiment of the image-based social media network application of the method and shows the geo-tagging screen.

FIG. 16 is a screen capture of one embodiment of the image-based social media network application of the method and shows the offer award screen before the user accepts an offer.

FIG. 17 is a screen capture of one embodiment of the image-based social media network application of the method and shows the offer award acceptance screen.

FIG. 18 is a block diagram of one embodiment of the image-based social media network application of the method and shows the system architecture of the image-based social media network application.

FIG. 19A is a screen capture of one embodiment of the image-based social media network application of the method and shows the Qpin screen with related functionality.

FIG. 19B is a screen capture of one embodiment of the image-based social media network application of the method and shows the Qpin screen with related functionality. record mode screen.

FIG. 20 is a screen capture of one embodiment of the image-based social media network application of the method and shows the record mode screen.

FIG. 21 is a screen capture of one embodiment of the image-based social media network application of the method and shows the record standby mode screen.

### DETAILED DESCRIPTION

in the following detailed description of various embodiments of the computer-based method, numerous specific details are set forth in order to provide a thorough understanding of various aspects of one or more embodiments. However, one or more embodiments of the method may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present method will become apparent to those skilled in the art from the following detailed description, which shows and describes illustrative embodiments of the method. As will be realized, the invention is capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “computer”, “computer system”, and “server” may refer to any device that processes information with an integrated circuit chip, including without limitation, mainframe computers, work stations, servers, desktop computers, portable computers, laptop computers, embedded computers, wireless devices including cellular phones, smart phones, tablet computers, personal digital assistants, digital media players, portable game players, and hand-held computers.

As used herein, the term “Internet” may refer to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “application”, “software”, and “software application” generally refer to any set of machine-readable instructions on a client machine, web interface, and/or computer, downloadable or externally hosted, which directs a computer's processor to perform specific steps, processes, or operations disclosed herein.

As used herein, the term “scrubbing” may refer to the control feature of moving forwards or backwards in the video file while the video file is still up and accessible. Scrubbing provides the ability to control the rate at which movements through the video can be made.

The term “socially networked” generally refers to two or more users connecting through the same social media network.

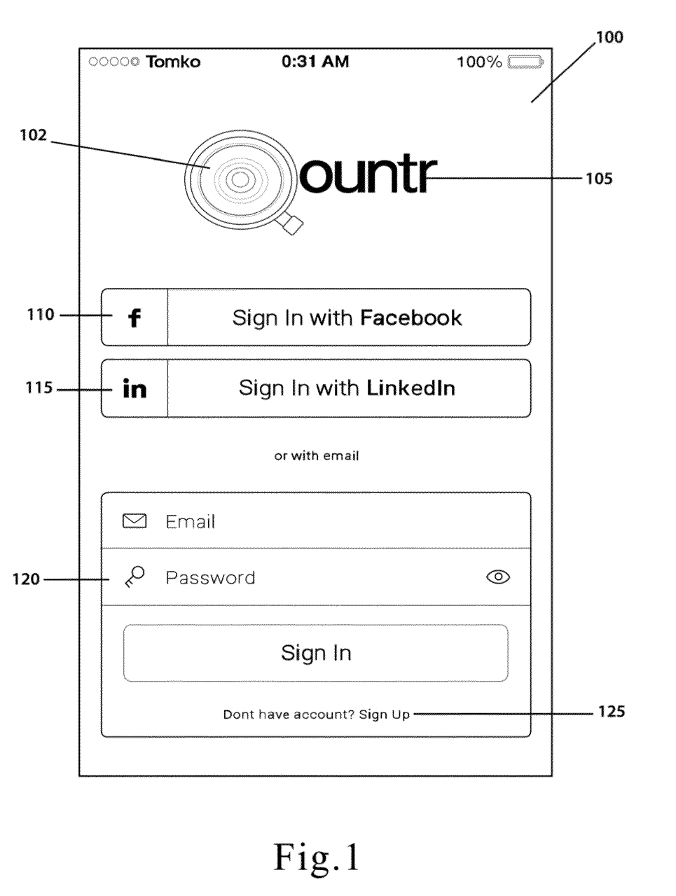

FIG. 1 is a screen capture of one embodiment of the image-based social media network application of the method and shows the login screen. As shown in FIG. 1, one embodiment of the image-based social media network application may have a login screen 100, which may be comprised of logo 102, trademark 105, prior related social media network sign-in options 110 and 11S, standard sign-in 120, and registration option 125. FIG. 1 shows that the starting page or screen for accessing the image-based social media network application is a sign in screen 100. The user may access his or her page by signing in using an existing social media network login 110 and 115. Alternatively, the user may use a dedicated standard sign-in 120, which may comprise a username, password, and execute button. In the event that the user has not yet set-up or created a user profile, the user may link to the profile page through the registration option 125.

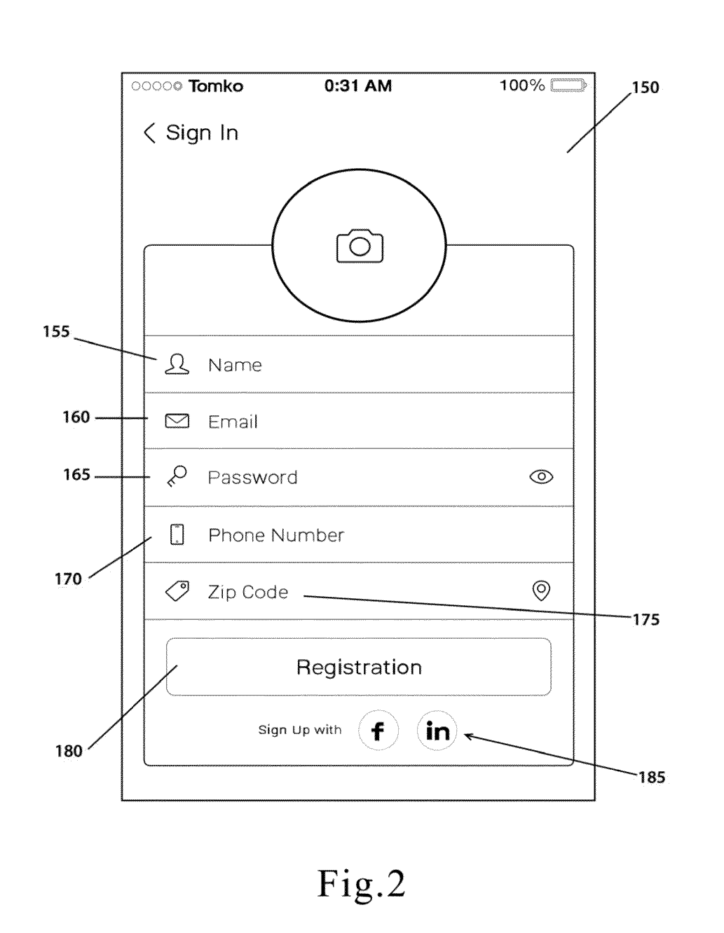

FIG. 2 is a screen capture of one embodiment of the image-based social media network application of the method and shows the registration screen. As shown in FIG. 2, the user may create a user profile by accessing the registration or sign-up screen 150. The registration screen 150 may request or require the user to enter identifying information, such as a name 155, email address 160, password 165, phone number 170, and zip code 175. The registration screen 150 may also comprise an execute registration button 180, and an alternative way to sign up by accessing the users' prior user profile set up in different social media networking program 185. The registration screen 150, however, may request or require more or less information about the user, depending upon the level of privacy and/or anonymity is desired.

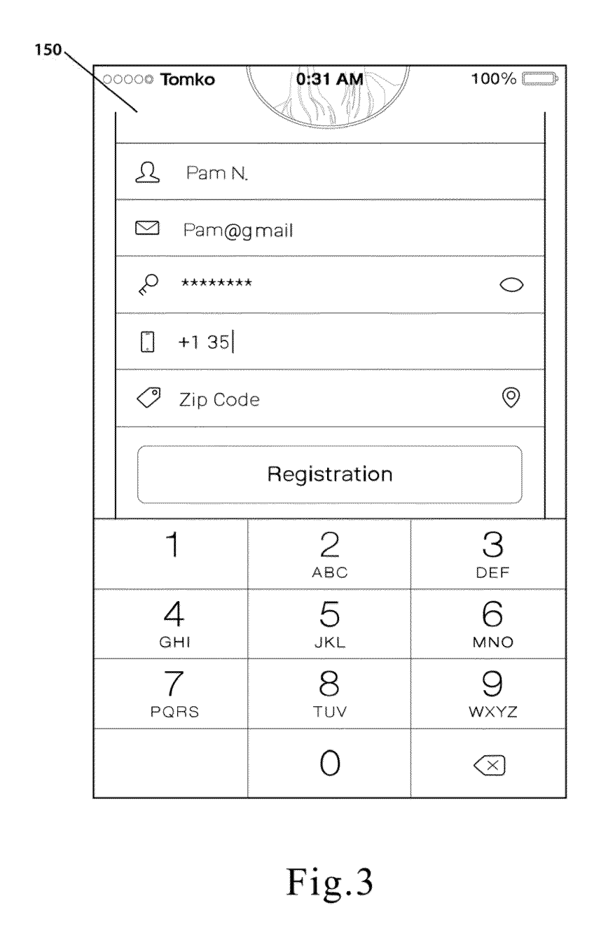

FIG. 3 is a screen capture of one embodiment of the image-based social media network application of the method and shows an example registration. As shown in FIG. 3, the user may enter information into registration screen 150 in order to create a user profile.

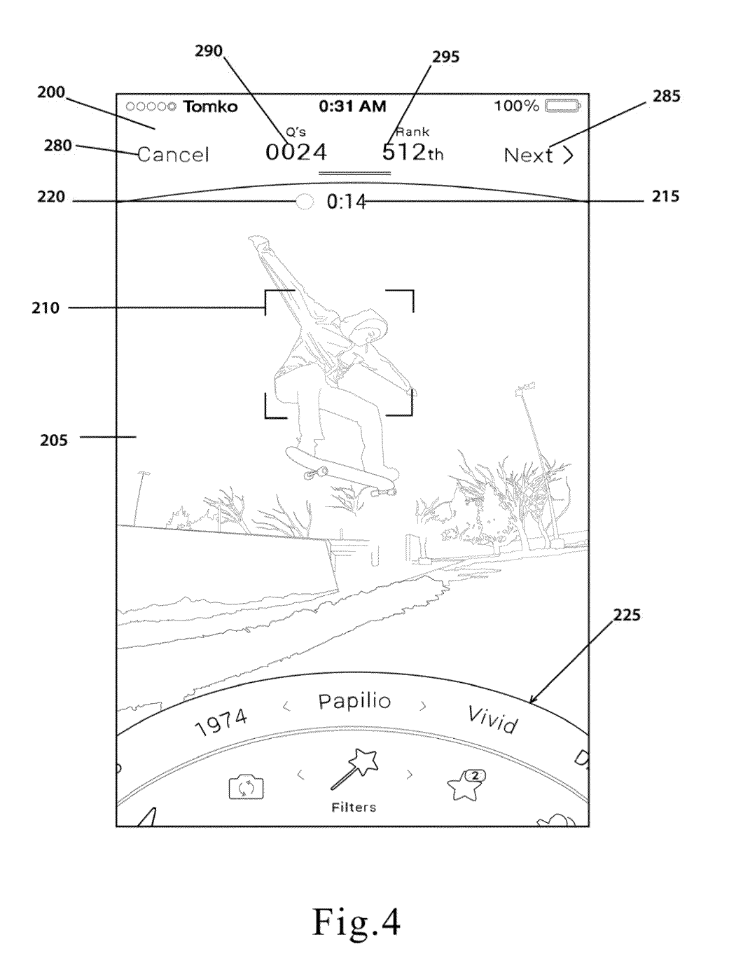

FIG. 4 is a screen capture of one embodiment of the image-based social media network application of the method and shows the image creation, filtering, and editing screen. As shown in FIG. 4, one embodiment of the creation or record screen 200 may comprise: a display 205, view finder 210, timer 215, record indicator 220, and navigation controls 225. In order to provide for seamless use and operation, the application may be on a device, such as a smart phone, which generally includes the ability to run the image-based social media network application and a camera. However, any type of device, with or without a camera may be used, including, but not limited to, a computer, a laptop computer, a portable computer, a tablet computer, a smart phone, a cellular phone, a portable game player, or digital camera. The camera of the device may have video capturing capability, and the user, through the social media network application, may use the device's camera to record a video.

Alternatively, a video may be uploaded to the application from an external source or internal file. In this manner, the device running the social media networking application need not include an integrated camera.

FIG. 4 shows how the navigation controls 225, which may be in the form of a soft key dial, may comprise: various controls, including flash, camera flip, filters, challenges (pending and otherwise) (also referred to as Qountrs™), and friends. The navigation controls 225 may have sub menus that may include options for each of the controls, such as on/off/dimmer for the flash, front/back/split for the camera flip, and named filters (such as 1/2/3/etc. . . . ).

FIG. 4 also shows how the display 205 may include image controls, such as cancel 280, next 285, create, record, edit, and scrub (fast forward/reverse). The record screen 200 may also display activity counts 290, or Q's™, and a user's rank 295.

As shown in FIG. 4, the editing and filter features of the social media networking application may be very extensive and may offer the user enhanced capabilities far beyond that which is provided for by current social media network systems and applications. A user may apply one or more filters to the same image or video and/or may change filters as many times as desired.

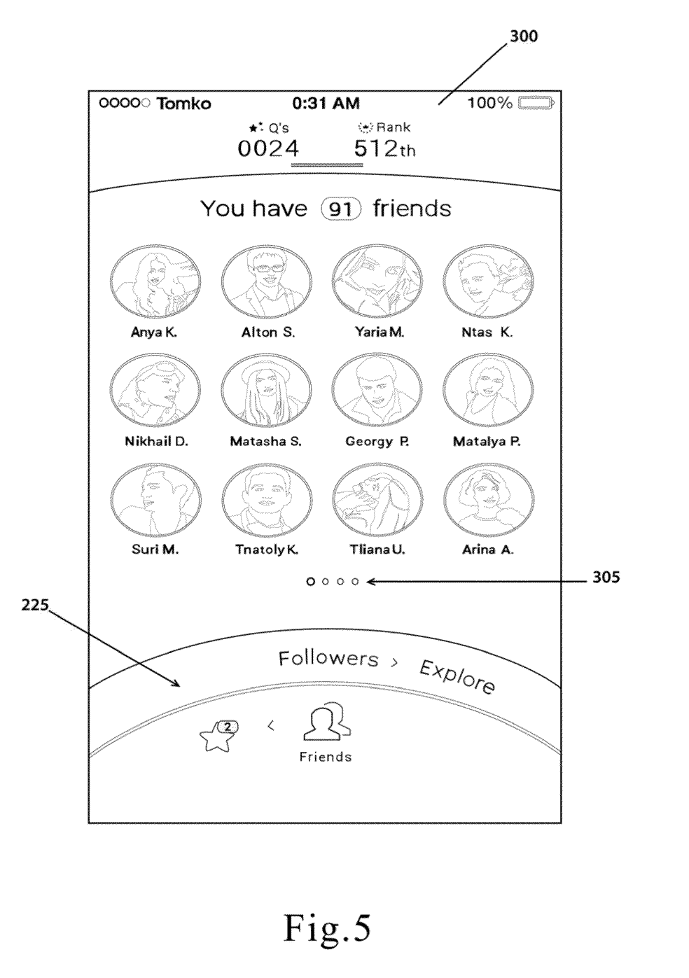

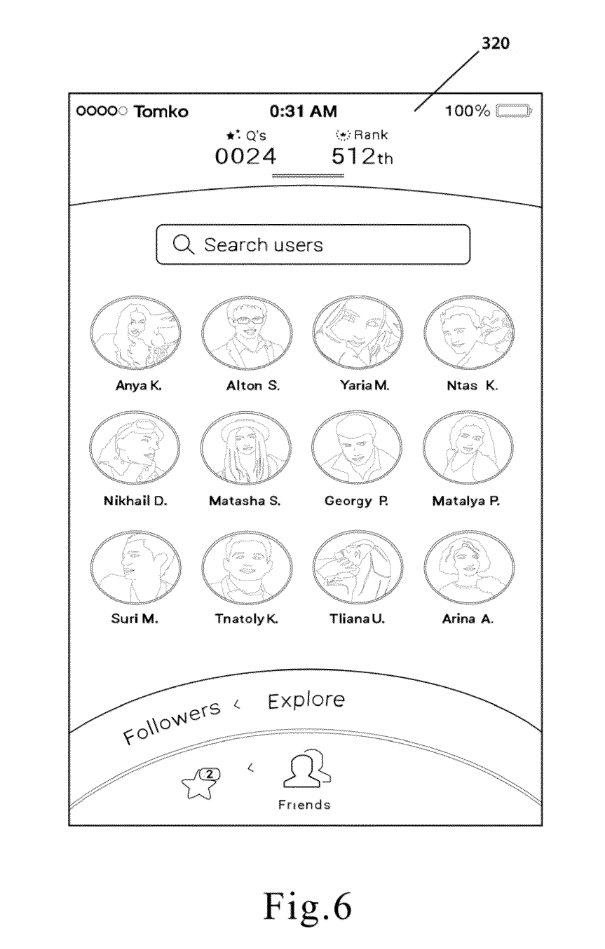

FIG. 5 is a screen capture of one embodiment of the image-based social media network application of the method and shows the networked friend directory page. Once the image has been created, edited, and finalized, the user may select other users to whom the image (which is generally a video, but may be a still image) will be sent. The image may be sent to a user's networked friends or be published globally for all members of the social media network. Typically, the image is sent to one or more of the user's networked friends. As shown in FIG. 5, the user may use the navigation controls 225 to view the friends screen 300. The editing control buttons may be disabled when not needed. The friends screen 300, as shown in FIG. 5, may display the friends' names and photo (or avatar). The friends screen 300 may have multiple pages 305, which the user may swipe to access. FIG. 5 shows how the friends screen has a sub-navigation that includes Followers (those friends following the user) and Explore, which is shown in FIG. 6. The navigation control 225 is used to switch between screens.

FIG. 6 is a screen capture of one embodiment of the image-based social media network application of the method and shows the friends search page. As shown in FIG. 6, one embodiment of the image-based social media network application may have a search or Explore page 320, which allows the user to search for friends in order to send the challenge images.

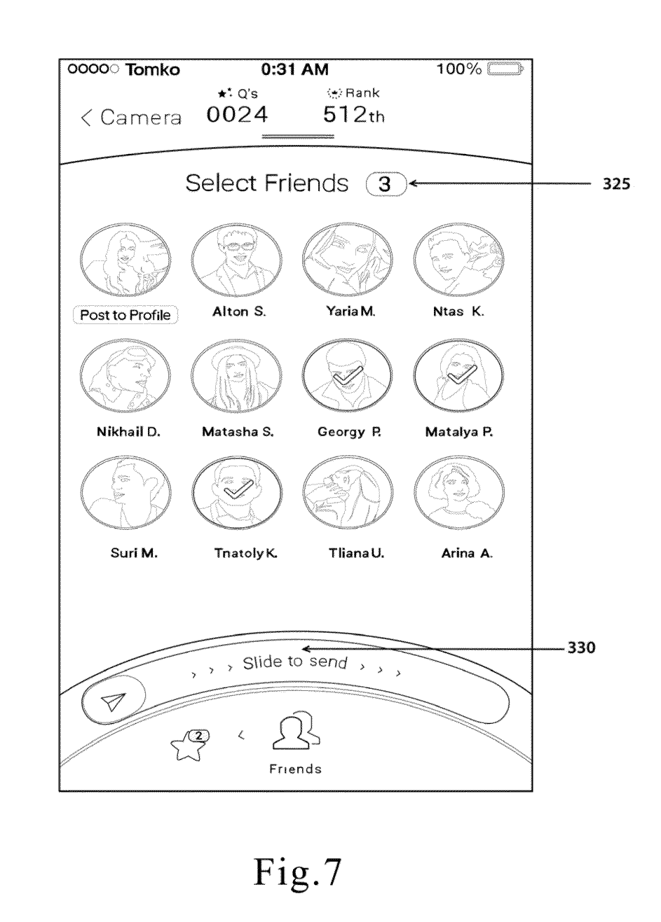

FIG. 7 is a screen capture of one embodiment of the image-based social media network application of the method and shows the friends selection page. As shown in FIG. 7, the user may select friends to send the challenge by selecting a specific friend's picture, name or avatar. FIG. 7 shows that each selected friend may receive a check to show the total number of friends selected 325. Once all of the desired friends are selected, the user may then use the navigation controls 330 to send the challenge to the selected friends.

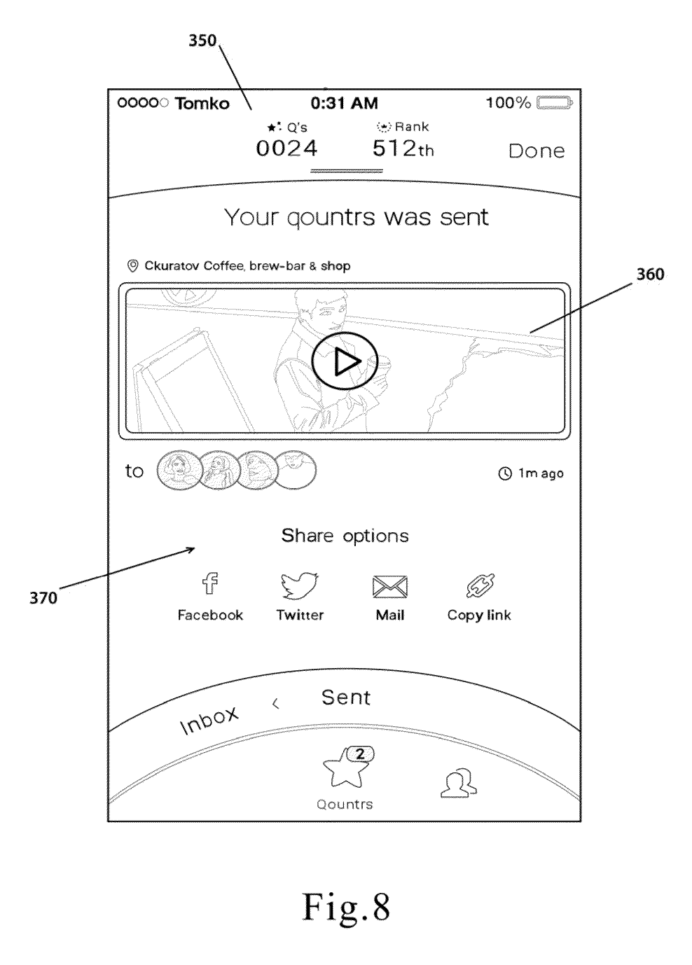

FIG. 8 is a screen capture of one embodiment of the image-based social media network application of the method and shows the challenge sent confirmation page. As shown in FIG. 8, one embodiment of the image-based social media network application may comprise a challenge sent confirmation screen 350, which confirms to the user that the challenge, or Qountr™, was sent. The confirmation screen 350 may comprise business offering/challenge 360, and share options 370, which may allow the user to post his or herself on other social media networks, or otherwise share the challenge.

The business challenges 360, also called Qountr Offers™ are generally submitted by business users. This may allow business users to make discounts or free offers for customers and potential customers, in the form of challenges. Regular users can redeem these offers through the application when they create or respond to a challenge at a physical location of the participating business. Users may also have the option to search for local deals/offers. This generally provides a service to the business users and the regular users without having intrusive ads.

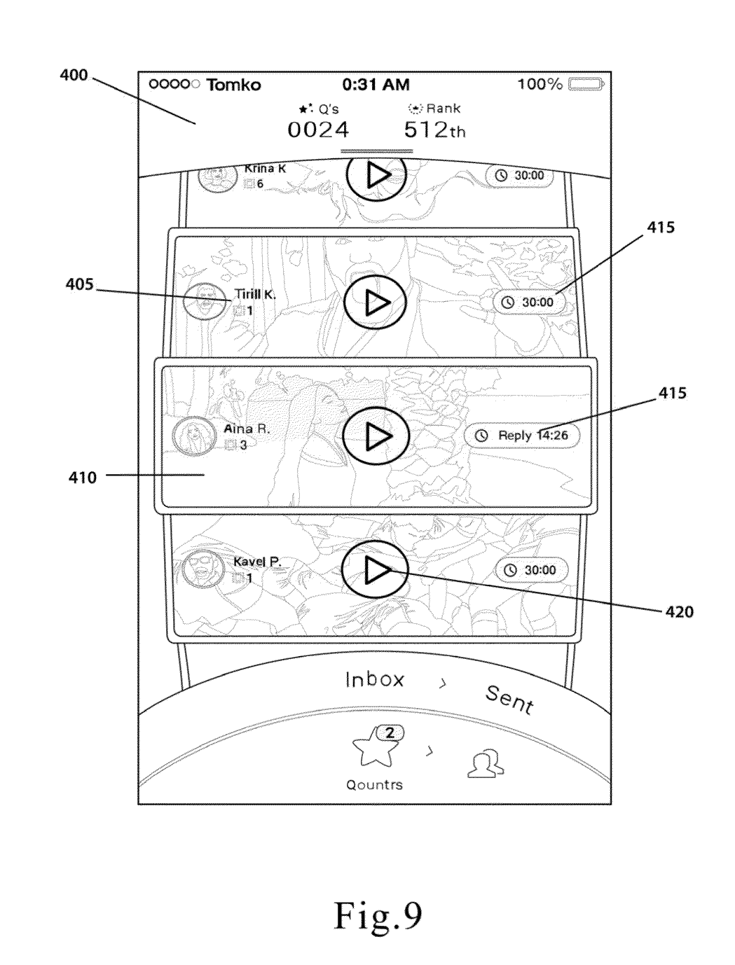

FIG. 9 is a screen capture of one embodiment of the image-based social media network application of the method and shows the challenge inbox screen. As shown in FIG. 9, the user may view incoming or available challenges at the challenge inbox screen 400. The challenges are generally listed with information on who sent the challenge 405, a still (or GIF) from the video 410, the duration of time left to respond to the video 415, and play buttons 420. The user may scroll through the challenges by moving the challenges up and down. Although the application shows the use of a touch screen and soft keys, the graphical user interface may be designed to include the use of hard keys and non-touch screen displays.

The challenges may also be listed in the inbox screen 400 for only a limited time, such as one, two, three, four, or five days. This generally prevents the challenge from being responded to in a stale fashion.

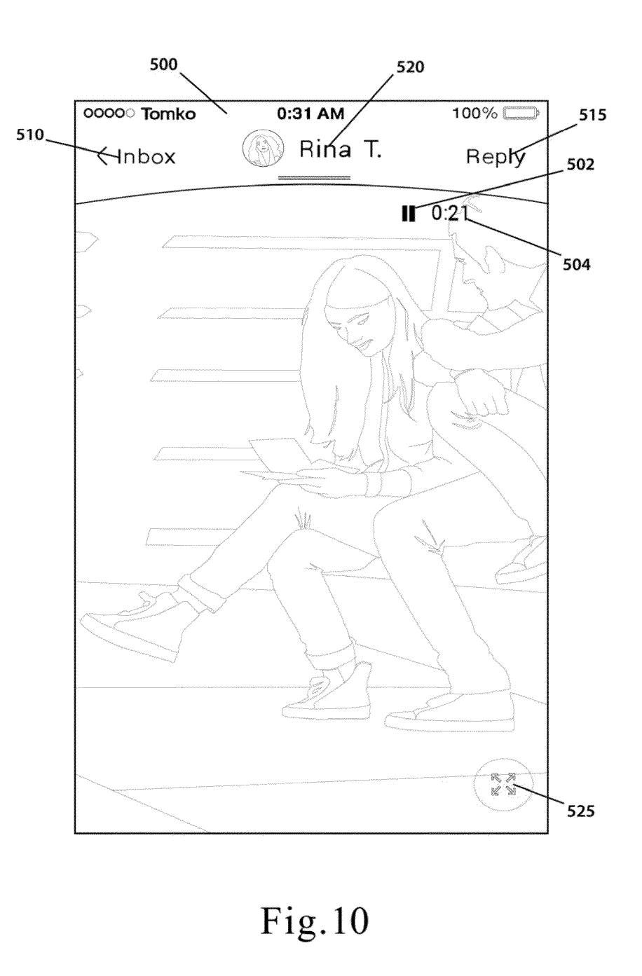

FIG. 10 is a screen capture of one embodiment of the image-based social media network application of the method and shows the challenge review screen. As shown in FIG. 10, when a challenge is selected, the challenge image may open up in a challenge review screen 500. The challenge review screen 500 may be configured to play the video, with the ability to pause 502, and track the duration 504. The video may also be scrubbed forward and back. The challenge review screen 500 may comprise an inbox button 510, a reply button 515, challenging user 520, and view control 525. Once a user views the challenge, the user may respond by creating their own video and sending it back to the original challenger and the other users that were challenged.

The application may provide an explore option so that users may find ideas for challenges or just entertain themselves with all of the public facing challenges or Qountrs™. Trending public videos may filter to the main website associated with the image-based social media network application. Users may then follow, like, and comment on the publically accessible videos. The users may also like and comment on the private challenge videos as well.

The application and method may give back to the most active and influential users. The method may allow users, who so desire, to receive an incentive, or be rewarded by obtaining an ownership share in the company that controls and/or owns the image-based social media network application. The incentive may be awarded based on all of the activity of user on the application and/or website. The image-based social media network application may use algorithms to determine the weight or strength of each type of activity. A score may be generated called the “Qount™”. As the user's score rise the user globally builds a rank on the image-based social media network application. The user's rank may be relative to the other users or the total amount of activity taking place in the social media network application.

Based on a user's rank, the application may then determine the fair reward for users who opt into the incentive portion of the method. Users are generally not required to participate with a no pressures of the monetization path.

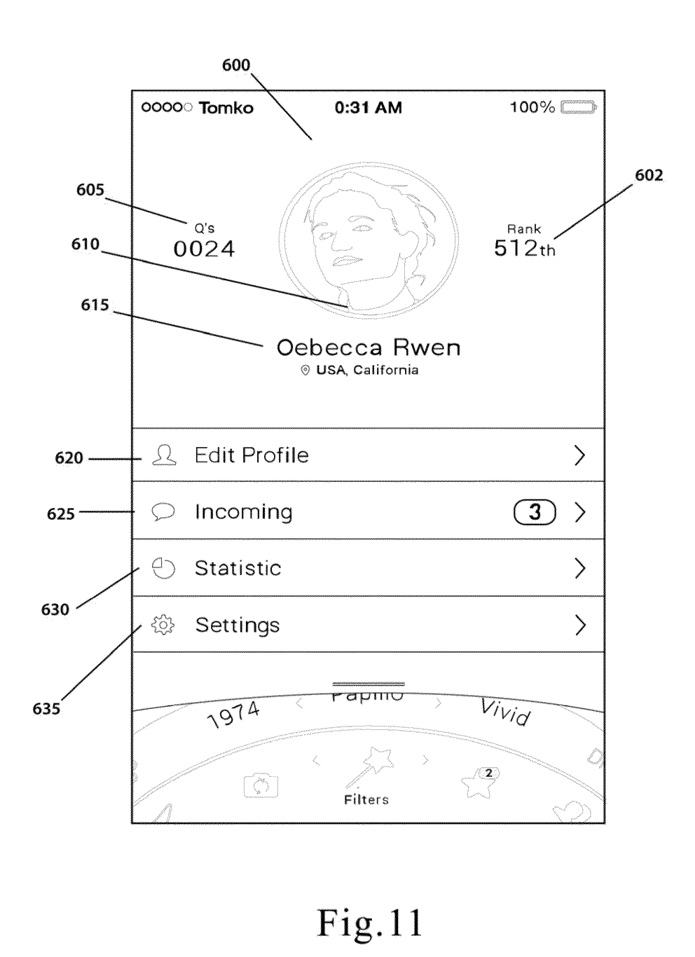

FIG. 11 is a screen capture of one embodiment of the image-based social media network application of the method and shows the profile rank screen. As shown in FIG. 11, one embodiment of the profile rank screen 600 may comprise the users rank 602, an activity level 605, a user's photo or avatar 610, user's name 615, edit profile 620, incoming challenges 625, statistics 630, and settings 635.

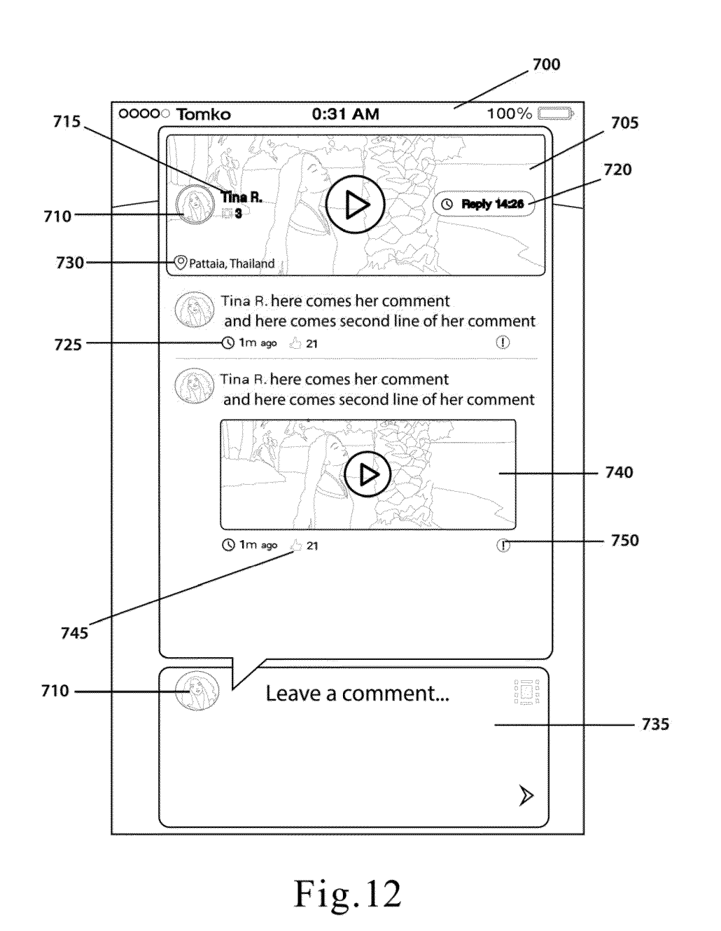

FIG. 12 is a screen capture of one embodiment of the image-based social media network application of the method and shows the comment screen. As shown in FIG. 12, one embodiment of the comment screen 700 may comprise: a still (or GIF) from the video 705, a user's photo or avatar 710, user's name 715, timer 720, time stamp 725, geo-location 730, comment box 735, response video 740, approval button 745, and flag button 750. FIG. 12 shows that users may provide comments in response to a challenge, video, and/or Qountr™ in the form of text, video (i.e., response video 740), or a combination of both in the comment box 735. A timer 720 may also be utilized to limit the amount of responses from other users. The time stamp 725 may show when the comment or video was added, and the geolocation 730 may indicate where the user created the video. A user may also approve a video or flag/report a video via the approval button 745 and flag button 750, respectively.

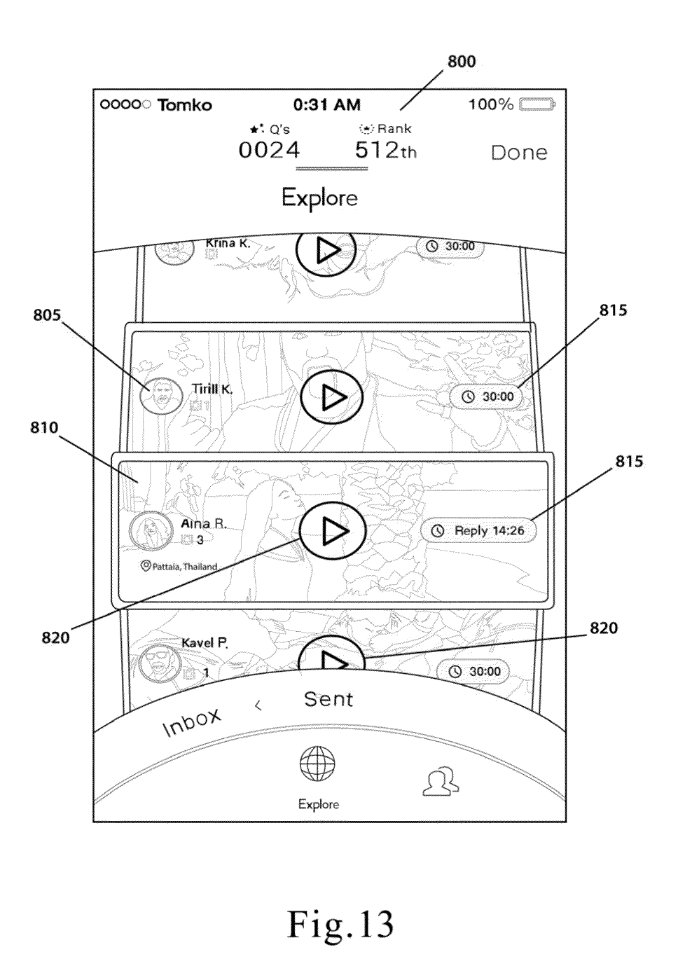

FIG. 13 is a screen capture of one embodiment of the image-based social media network application of the method and shows the explore screen. As shown in FIG. 13, the user may explore incoming or available challenges through the network via the explore screen 800. The challenges are generally listed with information on who created the challenge 805, a still (or GIF) from the video 810, the duration of time left to respond to the video 815, and play buttons 820. Like the challenge inbox screen 400, the explore screen 800 may allow the user to browse and/or scroll through the challenges in a network. The user may search for challenges by moving the challenges up and down such as a roulette-style fashion, and may also discover new friends and/or businesses who utilize popular Qountrs™. The challenges may also be listed in the explore screen 800 for only a limited time, such as one, two, three, four, or five days to prevent the challenge from being responded to in a stale fashion.

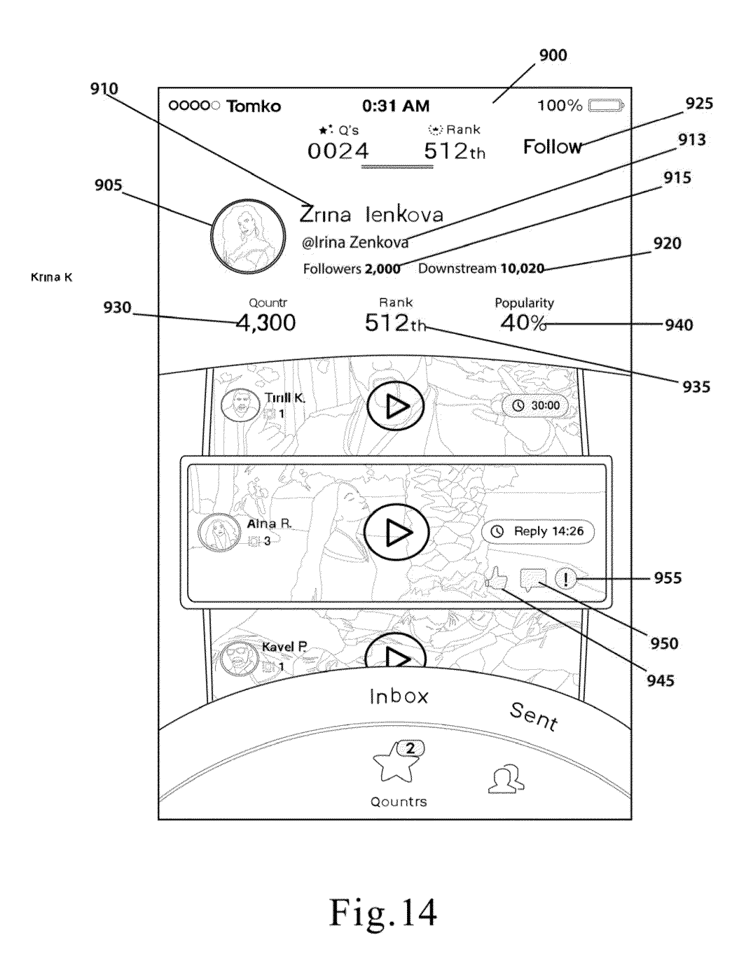

FIG. 14 is a screen capture of one embodiment of the image-based social media network application of the method and shows the user profile screen. As shown in FIG. 14, one embodiment of the user profile screen 900 may comprise: a user's photo or avatar 905, user's name 910, number of followers 915, number of downstream users 920, follow button 925, number of Qountrs™ 930, ranking 935, popularity statistic 940, approval button 945, comment button 950, and flag button 955. The user profile screen 900 may show brief information of each user such as the user's name 910, a usemame 913, the number of followers 915, and number of downstream users 920. Other information may also be included such as information of the last responding user, the number of replies to the challenge/Qountr™, and the geolocation of the user. Additionally, a different user may be shown in the user profile screen 900, when different challenges or Qountrs™ are selected. Furthermore, the user profile screen 900 may provide the ability to approve/like, comment, flag/report, and/or reply to a challenge/Qountr™.

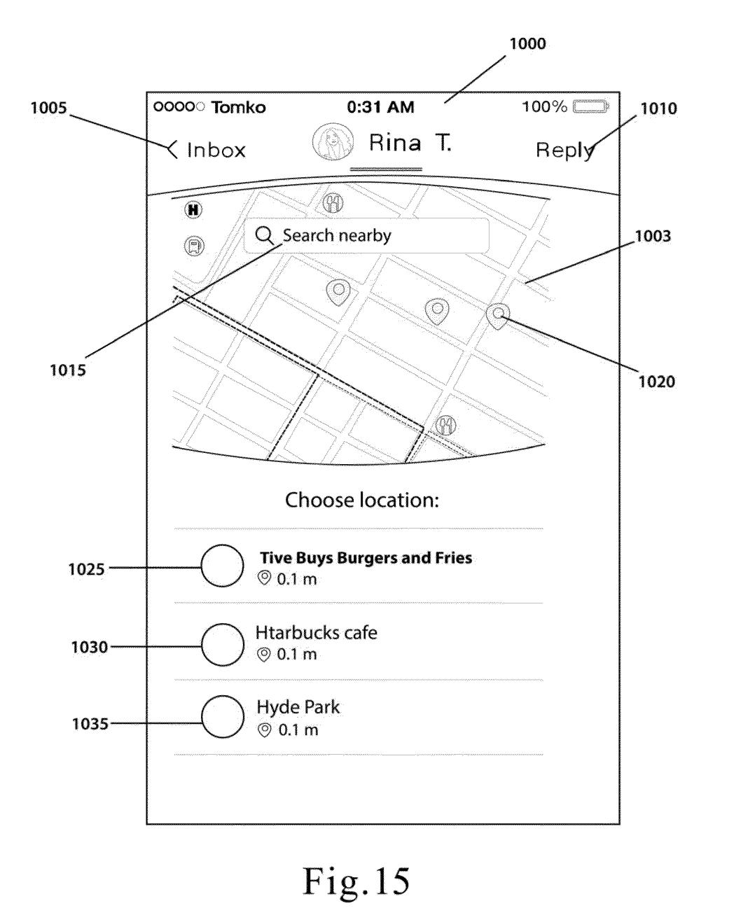

FIG. 15 is a screen capture of one embodiment of the image-based social media network application of the method and shows the geotagging screen. As shown in FIG. 15, one embodiment of the geotagging screen 1000 may comprise: a map 1003, inbox button 1005, reply button 1010, search function 1015, geotag 1020, and points of interests 1025, 1030, 1035. In the geotagging screen 1000, a user may tag a location on a map 1003 where the video or challenge was created. When tagging a location, businesses and points of interests 1025, 1030, 1035 may be populated to show relevant locations near the geotagged location. A user may alternatively utilize the search function 1015 to help find other relevant locations or points of interests on the map 1003. The search function may also help the user to find businesses and points of interests in situations where there is a large list of relevant locations to choose from. The inbox button 1005 may be used to navigate a user to the inbox and away from the geotagging screen, similar to a back button or cancel button. The reply button 1010 may be used to navigate the user back into sending or replying to challenges or Qountrs™. Although FIG. 15 only shows three points of interests, any number of points of interests may be populated in the geotagging screen.

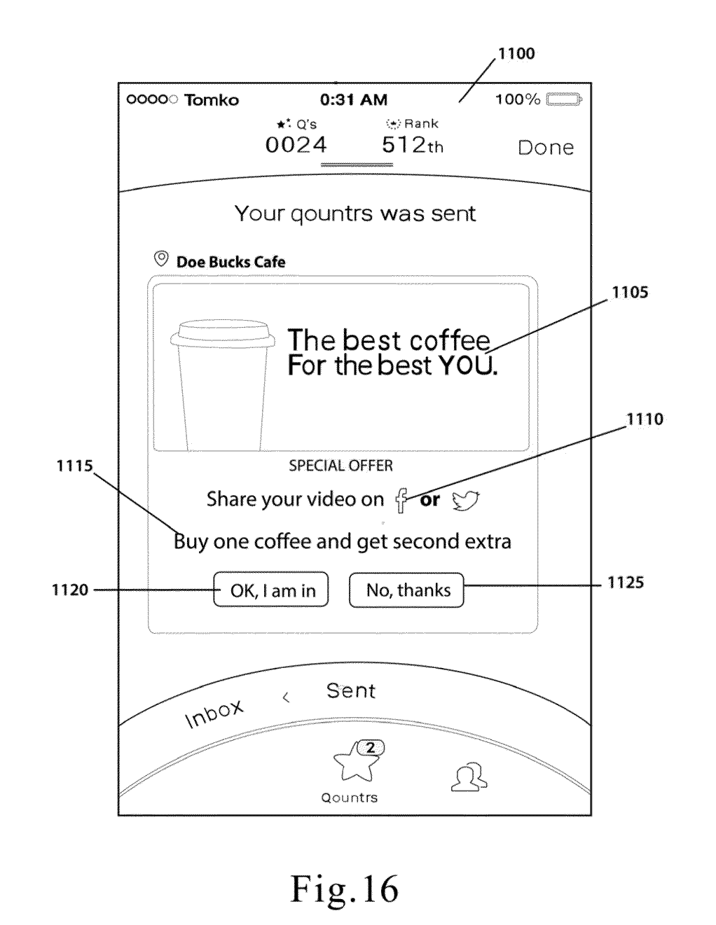

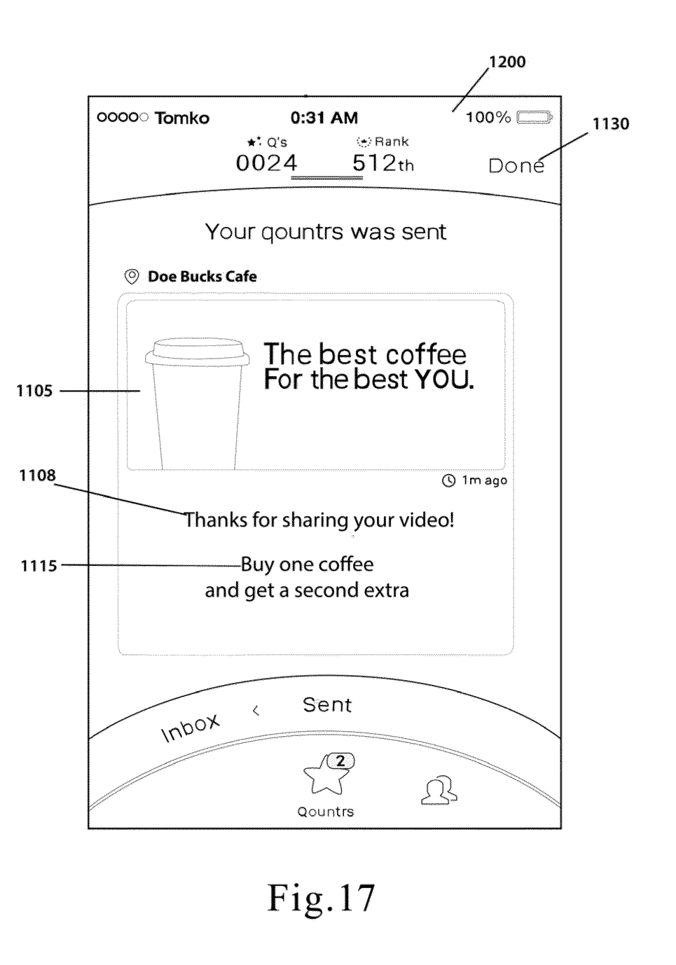

FIG. 16 is a screen capture of one embodiment of the image-based social media network application of the method and shows the offer award screen before the user accepts an offer. As shown in FIG. 16, one embodiment of the offer award screen 1100 may comprise: an advertisement 1105, one or more share buttons 1110, offer 1115, accept button 1120, and cancel button 1125. Upon sending a Qountr™, the user may be notified by one or more web services that the geotag is associated with a business account offer. Thus, an offer 1115 created by the business account may be sent and displayed to the user. The user may accept or decline the offer by selecting the accept button 1120 or cancel button 1125 and generally has the option to the share the offer to another network via the share buttons 1110. If the user accepts the offer, the user may be taken to the offer acceptance screen 1200 (shown in FIG. 17). Otherwise, the user may be returned to the previous screen such as the geotagging screen 1000 or explore screen 800. The advertisement 1105 may also be included to promote a product, service, or event.

FIG. 17 is a screen capture of one embodiment of the image-based social media network application of the method and shows the offer award acceptance screen. As shown in FIG. 17, another embodiment of the offer award acceptance screen 1200 may comprise: an advertisement 1105, acceptance message 1108, offer 1115, and done button 1030. After the user has accepted the offer 1115, an acceptance message 1108 may be shown to the user, thanking the user for accepting the offer. The advertisement 1105 and offer 1115 may still be displayed to the user, and the user may exit the screen by selecting the done button 1030.

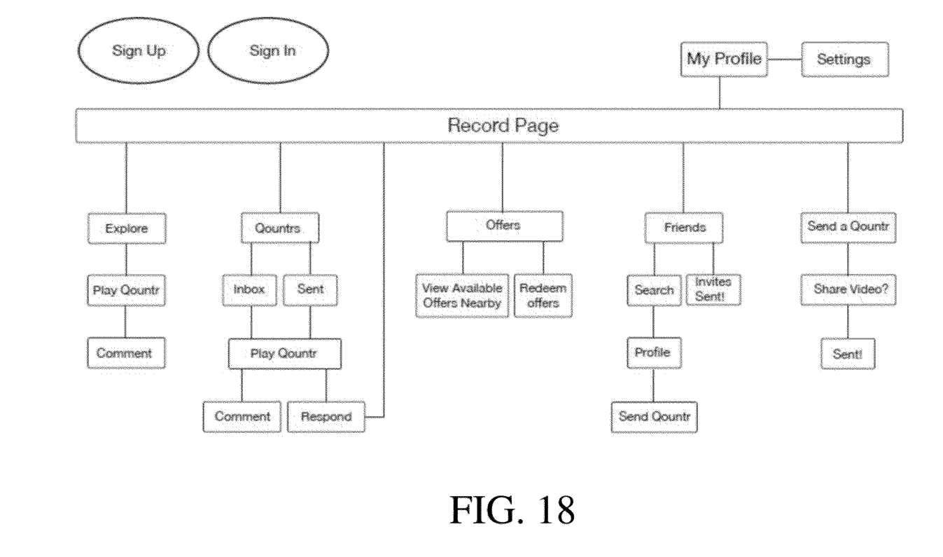

FIG. 18 is a block diagram of one embodiment of the image-based social media network application of the method and shows the system architecture of the image-based social media network application.

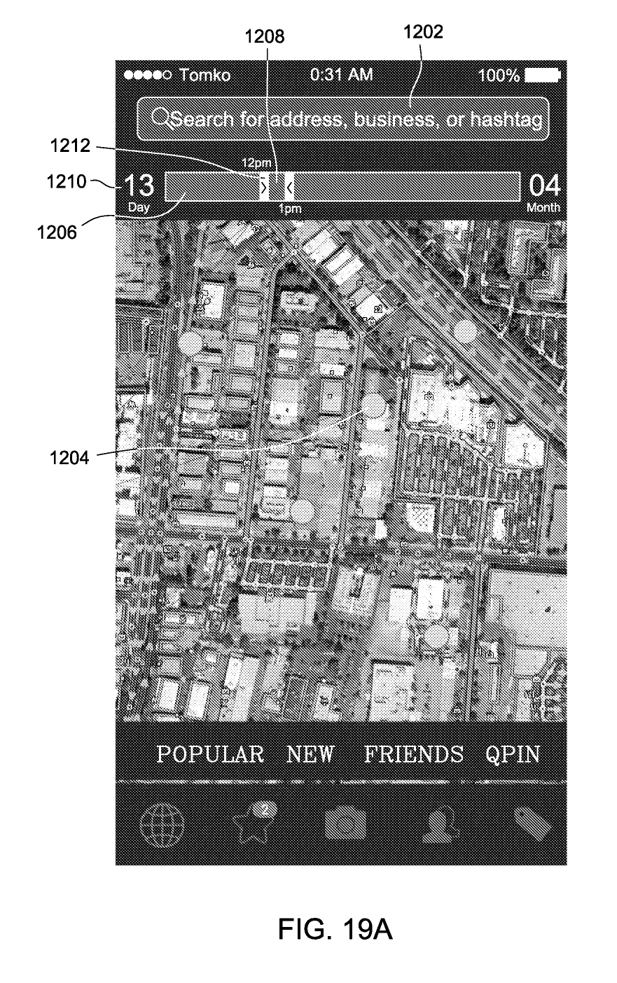

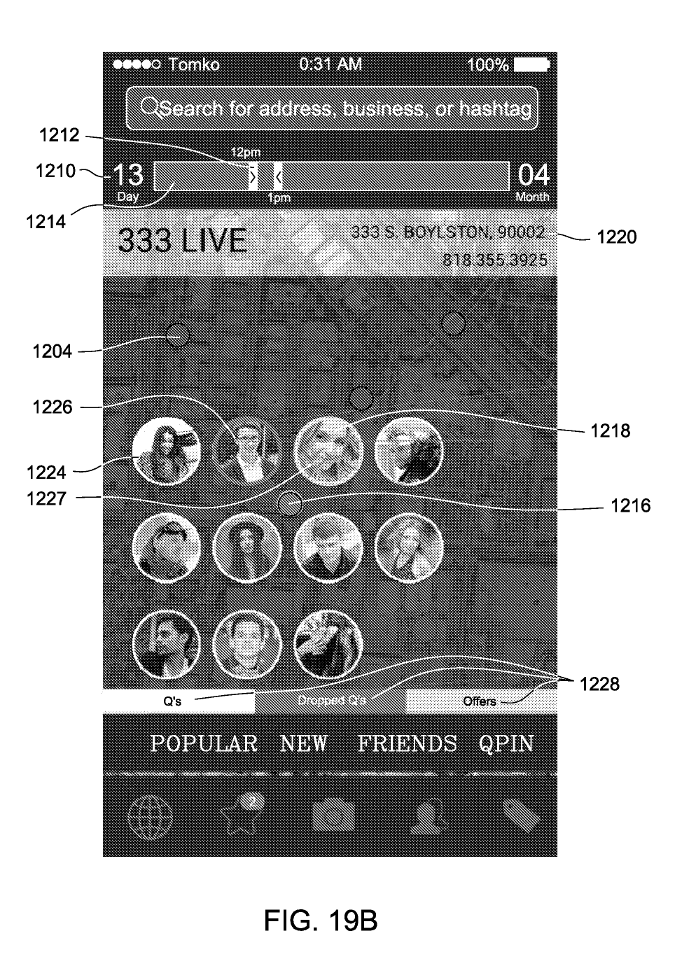

FIG. 19A is a screen capture of one embodiment of the image-based social media network application of the method and shows the Qpin screen and related functionality. The search field 1202 allows for address search, business name search and hashtag filtering. Additionally, searching will cause a zoom in or out to contain the search criteria within the viewport. Hashtag searches 1204 are begun based on geolocation and then zoom out to accommodate the search results. Each result will be represented by a yellow dot 1204. An address or business search searches for an address. If multiple addresses match, it will display a yellow dot 1204 for each match. If an address is an exact match with no multiples it will be displayed with a “go to” message as shown in FIG. 19B. The same logic applies for a business search. When an activity has occurred within the last fifteen minutes, the yellow dot 1204 will pulsate.

Still referring to FIG. 19A, dragging form the center of the capsule selector 1206 will move the one hour window 1208 forward or backward. Date selectors 1210 allow for date filtering, and swiping up or down will increment the day or month value. The time capsule selector allows for by default one hour increments for the last one hour. Pulling either edge of the capsule selectors 1212 will allow extending one hour increments up to a maximum of 24 hours. Time capsule selection shows yellow dots 1204 indicating life results of the criteria (e.g., hashtag, address, business name or just from geolocation. Each yellow dot 1204 represents a group of videos that are linked to object such as event, business name, address, and hashtag. Tapping a yellow dot 1204 will cause the application to go to the screen shown in FIG. 19B.

Referring to FIG. 19B, by default the time capsule selector will start on the far right, allowing the user to access the last twenty four hours of videos, when the selector is moved to a new day, the day and or month selector will update automatically. The date selector 1210 allows for date filtering, swiping up or down will increment the day or month value. The time capsule selector window 1214 allows for, by default, selecting one hour increments for the last one hour. Pulling either edge of the capsule selectors 1212 will allow extending, in one hour increments, the time up to a maximum of twenty four hours. Time capsule selection shows the live results of an object (e.g., hashtag, address, business name or event).

Still referring to FIG. 19B, blue dots 1216 are selected objects, in one embodiment changing from yellow to blue upon selection. Selecting an object will display all the videos overlaid on the map. The map will zoom out and organize placement of video bubbles 1218 to fit the screen. Tapping a blue dot 1216 will hide videos. When a yellow dot 1204 is selected, it becomes a blue dot 1216 and displays company or event information on the ribbon 1220 below the time capsule selector window 1214. The address and phone number on the ribbon 1220 are lined into the phone default app settings to make navigation and calling possible. Tapping a video will open a video into a review screen. Company created videos and offers are highlighted in red. Tapping a red highlighted bubble 1222 will display the offer or promotional content. Tapping another yellow dot 1204 will contract the blue dot 1216 and hide videos, and then new videos associated with the new object will be displayed. The ribbon will also update to display information specific to this object.

Still referring to FIG. 19B, when tapping a yellow dot, the focus of the map is centered and a dark shade goes over the map to provide contrast to the videos as the yellow dot 1204 turns to a blue dot 1216. Videos associated with a geolocation have three types; Q's 1224 which are videos originating from the geolocation (in one embodiment, white), dropped Q's 1226 which are videos originating outside of the geolocation but associated with the geolocation (in one embodiment, blue), and offers which are created from the event or business owner (in one embodiment, yellow). Each of these video types can be filtered to be seen or hidden by toggling from the filter legend 1228. Notably, when tap holding a distant location (e.g., 0.5 miles or more) will cause a dialog box to appear, asking if a user wants to drop a Q meaning to record a video associated with the location. The dialog box appears in both Qpin and tag locations. Tapping yes jumps to the send screen, while tapping no cancels the dialog. In the tag location screen, attempting to self tag at a distant location initiates the drop Q dialog.

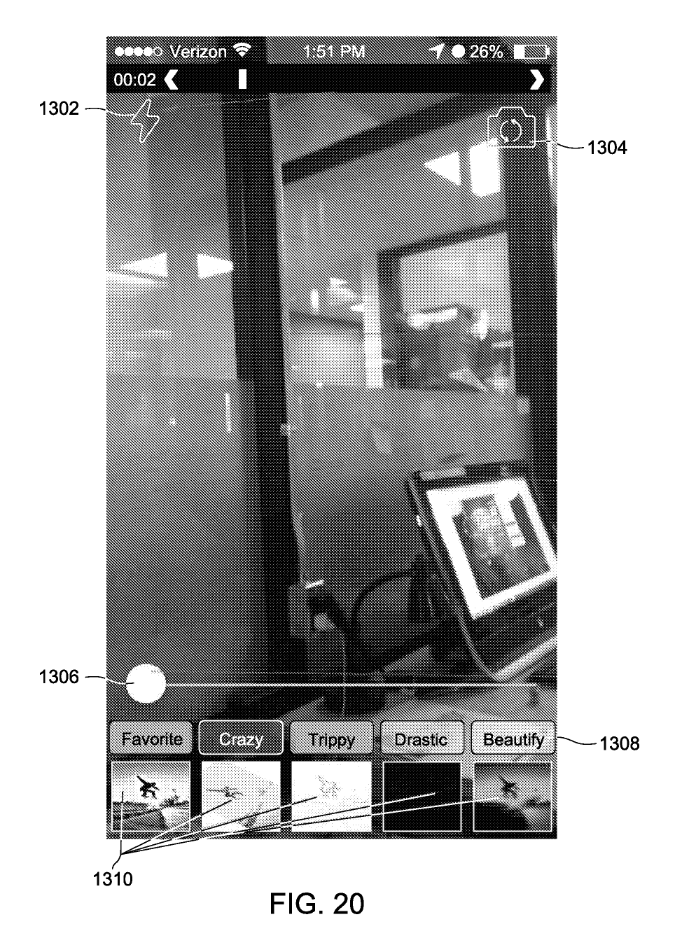

Referring to FIG. 20, a screen capture of the application's record mode is shown. Record mode includes a selectable live flash icon 1302 that enables a user to activate flash or strobe flash while a video is in standby or recording mode. A live camera flip icon 1304 enables users to flip the camera during the record mode and in standby to orient the image. In record mode, a single tap on the screen causes focus and auto exposure settings to adjust. A double tap causes recording and pausing recording. A live zoom slider 1306 enables users to zoom in or out live during record mode or in standby mode. At the bottom of the screen (or other positions in other embodiments) filter categories 1308 are shown which scroll (e.g., left and right) and contain filter presets categorized by the type of filter. Adjacent the filter categories 1308 are live filter presets 1310 which combine the output of at least two, but typically four filters to obtain a desired effect. Each of the filters can be toggled to enabled and disabled modes while recording and while in standby mode. The record function will capture all user-composed filter combinations life as the recording takes place.

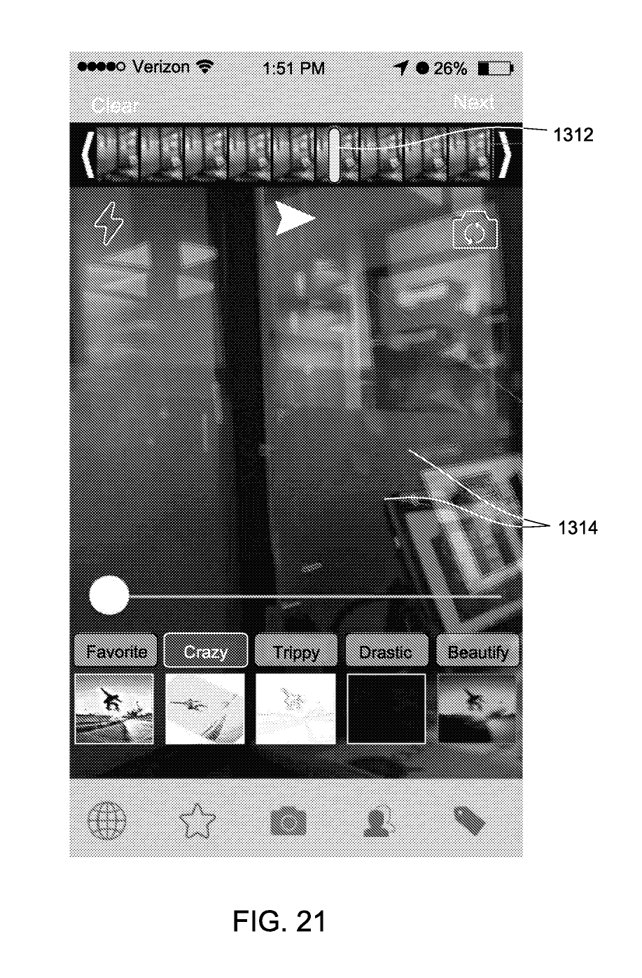

Referring to FIG. 21, a screen capture of the application's record standby mode is shown. Record standby includes a scrub timeline 1312 permitting advanced editing. A user may scrub through video thumbnails in the timeline while ghost alignment 1314 is displayed. When a user chooses the frame at which to begin recording, the user can insert or replace new video from a current position. Standby mode also includes a review mode which enables a user, while the record mode is in standby mode, to review the video captured in the recording buffer. Ghost alignment 1314 displays a semi opaque image of the current frame from the scrub timeline. Live video shows through the ghost image allowing shot alignment for the next instance of recording.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. A computer-based method for providing an image-based social media network, comprising:
providing a first computer, at least one second computer, and at least one server; providing a social media application;
wherein said first computer comprises said social media application for a first user; wherein said at least one second computer comprises said social media application for at least one second user;
wherein said social media application is configured to allow said first user and said at least one second user to be socially networked;
creating at least one video by said first user;
wherein said social media application comprises one or more image filters;
wherein said one or more image filters allow said at least one video to be altered and edited as desired by said first user;
uploading said at least one created video to said social media application by said first user;
creating a challenge by said first user via said social media application; wherein said challenge comprises said at least one created video;
sharing said challenge with said at least one second user via said social media application;
viewing said challenge by said at least one second user via said social media application;
responding to said challenge by said at least one second user via said social media application, such that at least one response is created, uploaded, and shared with said first user;
wherein said at least one response comprises at least one response video;
tracking by said social media application a plurality of activity engaged in by said first user and said plurality of activity engaged in by said at least one second user, such that said plurality of activity is tracked for all users;
generating by said social media application a score for each of said users based on said plurality of activity;
ranking by said social media application said users based on said score of each of said users; and
providing one or more incentives to a plurality of high ranking users.

2. The computer-based method for providing an image-based social media network of claim 1 further comprising creating a user profile by each of said users.

3. The computer-based method for providing an image-based social media network of claim 1 further comprising wherein said at least one second user responds to said challenge within an allotted time duration after viewing said challenge.

4. The computer-based method for providing an image-based social media network of claim 1 further comprising wherein said challenge comprises three states: unviewed, viewed, and responded to.

5. The computer-based method for providing an image-based social media network of claim 4 wherein said challenge is configured to remain in said unviewed state for at least three days.

6. The computer-based method for providing an image-based social media network of claim 1 further comprising selecting by said first user a winning response from said at least one response video; providing by said social media application an ability to comment on and approve of said challenge and said at least one response by said users; and commenting on and approving of said challenge and said at least one response by said users.

7. The computer-based method for providing an image-based social media network of claim 6 further comprising providing by said social media application an ability to comment on and approve of said challenge and said at least one response by a plurality of users not being challenged nor doing said challenge; and commenting on and approving of said challenge and said at least one response by said plurality of users not being challenged nor doing said challenge.

8. The computer-based method for providing an image-based social media network of claim 1 further comprising editing said challenge and said at least one response by scrubbing to any time position on said challenge and said at least one response; and
wherein said editing of said challenge and said at least one response further comprises changing said one or more image filters multiple times concurrently within said same challenge and within said same at least one response.

9. The computer-based method for providing an image-based social media network of claim 1 further comprising wherein said first computer and said at least one second computer are further comprises one or more display screens;
displaying on said one or more display screens said social media application;
wherein said social media application further comprises of one or more navigational buttons that are displayed on said one or more display screens;
wherein said social media application further comprises of one or more viewing screens; and
switching between said one or more viewing screens, such that said users may browse between a plurality of networked friends, editing options, said one or more image filters, and one or more video creation options.

10. The computer-based method for providing an image-based social media network of claim 9 further comprising exploring by at least one of said users on said social media application a plurality of publically available challenges and responses.

11. The computer-based method for providing an image-based social media network of claim 10 further comprising following by at least one of said users on said social media application one or more other users; and
notifying by said social media network application said users regarding steps to find said one or more other users.

12. The computer-based method for providing an image-based social media network of claim 1 wherein said one or more incentives are comprised of a share in a company that is controlling said social media application.

13. The computer-based method for providing an image-based social media network of claim 1 wherein said plurality of activity is selected from the group of activities consisting of:
creating said at least one video; issuing said challenge;
responding to said challenge;
commenting on said at least one video;
approving said at least one video; being followed by other users;
following other users;
promoting said social media application;
declaring at least one winner of said challenge; and
being declared said at least one winner of said challenge.

14. The computer-based method for providing an image-based social media network of claim 13 wherein said score of each of said users is based on said plurality of activities of each of said users as compared to a total plurality of activity of all users.

15. The computer-based method for providing an image-based social media network of claim 1 wherein not all of said users are required to participate in said ranking and said providing of said one or more incentives.

16. The computer-based method for providing an image-based social media network of claim 1 further comprising:
providing a business users section within said social media application; creating a business user profile by each of a plurality of business users; tendering one or more discounts and offers to said users of said social media application by one or more of said plurality of business users; and
redeeming by said users said one or more discounts and offers through said social media application.

17. The computer-based method for providing an image-based social media network of claim 1 further comprising:
wherein said redeeming is further comprised of responding to one or more challenges of said plurality of business users at one or more physical locations of said plurality of business users.

18. A computer-based method for providing an image-based social media network comprising:
providing a first computer, at least one second computer, and at least one server; providing a social media application;
wherein said first computer comprises said social media application for a first user;
wherein said at least one second computer comprises said social media application for at least one second user;
wherein said social media application is configured to allow said first user and said at least one second user to be socially networked;
creating a user profile by each of said users; creating at least one video by said first user;
wherein said social media application comprises one or more image filters;
wherein said one or more image filters is configured to allow said at least one video to be altered and edited as desired by said first user;
uploading said at least one created video to said social media application by said first user;
creating a challenge by said first user via said social media application;
wherein said challenge comprises said at least one created video;
sharing said challenge with said at least one second user via said social media application;
viewing said challenge by said at least one second user via said social media application;
responding to said challenge by said at least one second user via said social media application, such that at least one response is created, uploaded and shared with said first user;
wherein said at least one response comprises at least one response video;
wherein said at least one second user responds to said challenge within an allotted time duration after viewing said challenge;
wherein said challenge comprises three states: unviewed, viewed, and responded to;
wherein said challenge is configured to remain in said unviewed state for at least three days;
selecting by said first user a winning response from said at least one response video;
exploring by at least one of said users on said social media application a plurality of publically available challenges and responses.
providing by said social media application an ability to comment on and approve of said challenge and said at least one response by said users;
commenting on and approving of said challenge and said at least one response by said users;
tracking by said social media application a plurality of activity engaged in by said first user and said plurality of activity engaged in by said at least one second user, such that said plurality of activity is tracked for all users;
generating by said social media application a score for each of said users based on said plurality of activity;
ranking by said social media application said users based on said score of each of said users; and
providing one or more incentives to a plurality of high ranking users.

19. The computer-based method for providing an image-based social media network of claim 18 further comprising:
providing by said social media application an ability to comment on and approve of said challenge and said at least one response by a plurality of users not being challenged nor doing said challenge;
commenting on and approving of said challenge and said at least one response by said plurality of users not being challenged nor doing said challenge;
editing said challenge and said at least one response by scrubbing to any time position on said challenge and said at least one response;
wherein said editing of said challenge and said at least one response comprises changing said one or more image filters multiple times concurrently within said same challenge and within said same at least one response;
wherein said first computer and said at least one second computer further comprises one or more display screens;
displaying on said one or more display screens said social media application; wherein said social media application further comprises one or more navigational buttons that are displayed on said one or more display screens;
wherein said social media application further comprises one or more viewing screens;
switching between said one or more viewing screens, such that said users may browse between a plurality of networked friends, one or more editing options, said one or more image filters, and one or more video creation options;
following by at least one of said users on said social media application one or more other users;
notifying by said social media network application said users regarding how to find said one or more other users;
wherein said one or more incentives comprises a share in said company that is controlling said social media network application;
wherein said plurality of activity is selected from the group of activities consisting of: creating said at least one video; issuing said challenge; responding to said challenge, commenting on said at least one video, approving of said at least one video, being followed by other users, following other users promoting said social media application, declaring at least one winner of said challenge, and being declared said at least one winner of said challenge;
wherein said score of each of said users based on said plurality of activities of each of said users as compared to a total plurality of activity of all users; and
wherein not all of said users are required to participate in said ranking and said providing of said one or more incentives.

20. The computer-based method for providing an image-based social media network of claim 19 further comprising:
providing a business users section within said social media application;
creating a business user profile by each of a plurality of business users;
tendering one or more discounts and offers to said users of said social media application by one or more of said plurality of business users;
redeeming by said users said one or more discounts and offers through said social media application; and
wherein said redeeming comprises responding to one or more challenges of said plurality of business users at one or more physical locations of said plurality of business users.
